(19) United States
(12) Patent Application Publication
(10) Pub. No.: US 2026/0362056 A1
(43) Pub. Date: Nov. 12, 2026

(54) AUDIO SYSTEM AND INSTRUMENT PANEL

(71) Applicant: Re:Car Inc., Troy, MI (US)

(72) Inventors: Tomoyuki Ishiwata, Fountain Valley, CA (US); Charles Waelti, Huntington Beach, CA (US); Andrew Sulkowski, Howell, MI (US); Scott Anderson, Commerce Twp., MI (US); Steven Leu, Troy, MI (US); Kirill Ponomarenko, Huntington Woods, MI (US); Rodney Romain, II, Clay, MI (US)

(21) Appl. No.: 19/644,351

(22) Filed: Apr. 10, 2026

Related U.S. Application Data
(60) Provisional application No. 63/786,846, filed on Apr. 10, 2025.

(51) Int. Cl. H04R 3/12; B60K 35/26; H04R 1/02; H04R 5/02

(52) U.S. Cl. CPC H04R 3/12; B60K 35/26; H04R 1/025; H04R 1/026; H04R 5/02; B60K 2360/586; B60K 2360/5905; B60K 2360/5911; B60K 2360/828; H04R 2420/07; H04R 2499/13

(57) ABSTRACT

An audio system for a vehicle, comprising a plurality of speaker units. The plurality of speaker units include at least one first speaker unit including a driver speaker unit which includes a power input for an external power source, and one or more second speaker units, at least one of which includes a battery. The driver speaker unit wirelessly communicates audio signals to the at least one second speaker unit.

### CROSS-REFERENCE TO RELATED APPLICATIONS

The present application claims benefit of U.S. Provisional Application No. 63/786,846, filed Apr. 10, 2025, and incorporated herein by reference in its entirety.

### FIELD

The present teachings generally relate to an audio system, an instrument panel and/or a door comprising at least a portion of the audio system, and a vehicle in which the audio system is operative.

### BACKGROUND

Vehicles typically come equipped with some hardware for projecting audio within the cabin. This hardware is integrated into the vehicle at the factory and generally is hidden in various vehicle components like doors, pillars, etc. This hardware is typically not designed or constructed to be replaced, relocated, or otherwise without destruction or plastic deformation of vehicle components, without great effort, or without specialized tools and know-how.

There remains a need for modular audio systems that can be replaced or relocated without destruction or plastic deformation of vehicle components, without great effort, or without specialized tools and know-how. There remains a need for modular audio systems that can be set up by the end-user in a first row configuration or a first and second row configuration.

### SUMMARY

The present disclosure relates to an audio system, which may address at least some of the needs identified above. The audio system may comprise a plurality of speaker units including: at least one first speaker unit including a driver speaker unit which includes a power input for an external power source, and one or more second speaker units, at least one of which includes a battery (e.g., an internal battery, such as an internal rechargeable battery). The driver speaker unit may wirelessly communicate audio signals to the at least one second speaker unit.

The at least one first speaker unit may further include one or more auxiliary speaker units, preferably a left auxiliary speaker unit and a right auxiliary speaker unit. The driver speaker unit may communicate audio signals to the one or more auxiliary speaker units (e.g., via a wired and/or wireless connection, preferably a wired connection).

The one or more second speaker units may include a center mounted speaker unit, a left mounted speaker unit, a right mounted speaker unit, or any combination thereof. Preferably at least two of the foregoing.

The one or more second speaker units may each include a wireless network module. The wireless network modules may be adapted and configured to communicate according to SKAA, Bluetooth, Wi-Fi, or any combination thereof (preferably SKAA). The driver speaker unit may include a wireless network module for wirelessly communicating the audio signals to the one or more second speaker units.

The one or more second speaker units may include two or more second speaker units adapted and configured to operate in surround sound.

The driver speaker unit and the one or more auxiliary speaker units may be adapted and configured to operate in surround sound.

The one or more auxiliary speaker units may include a power unput for the external power source. The one or more auxiliary speaker units and the driver speaker unit may comprise on-board amplifiers.

The one or more second speaker units may include at least one second speaker unit having a power input for the external power source.

The left mounted speaker unit and the right mounted speaker unit may each have a power input for the external power source.

The external power source may be a vehicle-borne power source (e.g., an electric vehicle battery such as a lithium-ion battery or an automotive battery such as a lead-acid battery).

The driver speaker unit may comprise a subwoofer.

The audio system may comprise an audio endpoint that signally communicates (e.g., via a wired or wireless connection) with the driver speaker unit and controls operation of the audio system. The audio endpoint may be a mobile device.

The present disclosure relates to a vehicle, which may address at least some of the needs identified above. The vehicle may comprise an audio system according to any one or combination of the foregoing paragraphs. The vehicle may be an electric vehicle. The vehicle may be a reconfigurable vehicle.

The vehicle may comprise a front occupant space and a rear occupant space. The at least one first speaker unit may be located in the front occupant space and at least one of the one or more second speaker units may be located in the rear occupant space.

The at least one first speaker unit may be located on or in an instrument panel of the vehicle.

The center mounted speaker unit may be located on the instrument panel and the left and right mounted speaker units may be respectively located on left and right rear doors of the vehicle.

The audio endpoint may form a wired connection with the vehicle and signally communicate with the driver speaker unit.

The vehicle may comprise one or more wiring harnesses. The one or more wiring harnesses may be adapted and configured to connect to one or more of the at least one first speaker unit.

The vehicle may comprise induction contacts or surface contacts (e.g., spring contacts) that form a conductive connection with the one or more second speaker units.

The vehicle may comprise channels (e.g., in the form of T-rails) on an instrument panel, one or more doors, one or both B-pillars, or any combination thereof. The induction contacts or surface contacts may be located in the channels.

The present disclosure relates to an instrument panel, which may address at least some of the needs identified above. The instrument panel may be comprised a vehicle. The vehicle may be an electric vehicle. The vehicle may be a reconfigurable vehicle. The instrument panel may comprise one or more bins. The vehicle may further comprise one or more cradles located in each of the one or more bins, and adapted and configured for receiving the one or more speaker units.

The one or more cradles may include a flange that engages one or more lips of the one or more bins. The one or more cradles may include through-holes on the flange for fastening the one or more cradles to the one or more bins.

The one or more cradles may include an open end adapted and configured for locating a wiring harness through.

The one or more cradles may include a recess in which a flange of a speaker unit locates and upon which the speaker unit is supported.

The instrument panel may include one or more doors and/or covers for covering the one or more bins, adapted and configured to be at least partially acoustically transparent. The door and/or cover may comprise: a base, a substrate, and a scrim material.

The base and the substrate may comprise holes, which contribute to the acoustic transparency thereof. The holes of the base may be larger in area compared to the holes of the substrate, or vice versa.

The one or more of the doors and/or covers may comprise a lock mechanism.

The base may comprise opposing hinge arms and pins thereon which form a hinged engagement with the instrument panel.

The present disclosure relates to a vehicle, which may address at least some of the needs identified above. The vehicle may comprise one or more channels. The vehicle may be an electric vehicle. The vehicle may be a reconfigurable vehicle. The one or more channels may mate with one or more speaker units.

The one or more channels may include a first channel located on an instrument panel of the vehicle. The channel may be located below a control cluster (e.g., a climate control cluster).

The one or more channels may include one or more second channels located on one or more doors of the vehicle, preferably left and right rear doors.

The one or more channels may include one or more third channels located on a B-pillar of the vehicle.

The one or more channels may include an inductive charging mechanism, surface contacts (e.g., spring contacts), or both. The inductive charging mechanism and the surface contacts may be connected to a power source on-board the vehicle.

The present disclosure relates to a speaker holder, which may address at least some of the needs identified above. The speaker holder may be comprised by a vehicle. The vehicle may be an electric vehicle. The vehicle may be a reconfigurable vehicle. The speaker holder may mate with one or more speaker units, one or more channels, or both.

The speaker holder may comprise a first segment and a second segment that are slidably adjustable relative to each other to define a region therebetween adapted and configured to accept a speaker unit. A cross-sectional profile of the speaker holder may be generally polygonal with radiused corners.

Each of the first and second segments may comprise a curved lip defining a space through which a speaker unit passes to become engaged with the speaker holder.

The first and second segments may comprise a fastening mechanism to set a position of the first segment relative to the second segment. The fastening mechanism may include a screw, a compression latch, or both.

The first and second segments may each have overlapping segments.

The first and second segments may comprise a plurality of holes adapted and configured to permit sound to pass through.

The first and/or second segments may comprise gripping elements.

The first and/or second segments may comprise one or more engagement features (e.g., clips) adapted and configured to be accepted within the one or more channels (e.g., T-rails).

The speaker holder may further comprise a strap and buckle that connects at one end to the first segment and at an opposing end to the second segment.

The first and second segments may be fabricated from ABS, optionally filled with a fiber (e.g., a glass fiber) The present teachings contemplate that the audio system, the instrument panel, the channels, the speaker holder, or any combination thereof may be employed in a vehicle. The vehicle may be an electric vehicle. The vehicle may be a reconfigurable vehicle. The foregoing is applicable to all embodiments.

### BRIEF DESCRIPTIONS OF THE DRAWINGS

FIG. 1 is a schematic view of an audio system according to the present teachings.

FIG. 2 is a schematic view of an audio system according to the present teachings.

FIG. 3 is a perspective view of a vehicle according to the present teachings.

FIG. 4 is a perspective view of a vehicle according to the present teachings.

FIG. 5 is a perspective view of an instrument panel according to the present teachings.

FIG. 6A is a perspective view of a door according to the present teachings.

FIG. 6B is a perspective view of a door according to the present teachings.

FIG. 6C is a perspective view of a door according to the present teachings.

FIG. 6D is a perspective view of a door according to the present teachings.

FIG. 7A is a perspective view of an instrument panel according to the present teachings.

FIG. 7B is a perspective view of an instrument panel according to the present teachings.

FIG. 7C is a perspective view of an instrument panel according to the present teachings.

FIG. 8A is a perspective view of an instrument panel according to the present teachings.

FIG. 8B is a perspective view of an instrument panel according to the present teachings.

FIG. 8C is a perspective view of an instrument panel according to the present teachings.

FIG. 9A is a perspective view of an instrument panel according to the present teachings.

FIG. 9B is a perspective view of an instrument panel according to the present teachings.

FIG. 9C is a perspective view of an instrument panel according to the present teachings.

FIG. 10A is a plan view of a speaker unit according to the present teachings.

FIG. 10B is a plan view of a speaker unit according to the present teachings.

FIG. 11A is a perspective view of a speaker holder according to the present teachings.

FIG. 11B is a perspective view of a speaker holder according to the present teachings.

FIG. 11C is a perspective view of a speaker holder according to the present teachings.

FIG. 11D is a perspective view of a speaker holder according to the present teachings.

FIG. 12A is a plan view of a speaker holder and speaker according to the present teachings.

FIG. 12B is a plan view of a speaker holder and speaker according to the present teachings.

FIG. 13 is a perspective view of an instrument panel according to the present teachings.

FIG. 14A is a perspective view of an instrument panel according to the present teachings.

FIG. 14B is a perspective view of an instrument panel according to the present teachings.

FIG. 14C is a perspective view of an instrument panel according to the present teachings.

FIG. 14D is a perspective view of an instrument panel according to the present teachings.

FIG. 15 is a perspective view of an instrument panel according to the present teachings.

FIG. 16 is a perspective view of speaker units according to the present teachings.

FIG. 17 is a perspective view of an instrument panel according to the present teachings.

### DETAILED DESCRIPTION

The description herein pertains to automotive vehicles. Preferably, it pertains to a vehicle that can be reconfigured from a first vehicle configuration to a second vehicle configuration. The vehicle can be reconfigured back to the first vehicle configuration. In other words, the vehicle has a reversible configurable structure.

In the context of the present description, “reversibly configurable” refers to structure having ability to be reconfigured (e.g., converted or transformed) from a first configuration to a second configuration and back to the first configuration. In this regard, “reversibly configurable” includes an ability of a structure to be reconfigured without permanently altering the structure in a way that would inhibit the structure from being reconfigured back to a previous configuration. For example, the structure may be reversibly configured from and/or between the first vehicle configuration to a second vehicle configuration without using permanent fasteners like adhesives or welding. For example, the structure may be reversibly configured from and/or between a first vehicle configuration to a second vehicle configuration without the need for using destructive material removal techniques causing permanent deformation such as cutting, milling, grinding, etc.

However, in some configurations, if drilling other insignificant plastic deformation is required to reconfigure the vehicle from or between the first and second vehicle configuration, such drilling is minimal and in accordance with an instruction approved by the original equipment manufacturer so that it avoids compromising structural integrity of the frame, and/or does not interfere with design and/or performance specifications of the original equipment manufacturer. For example, “reversibly configurable” includes an ability of a structure to be reconfigured with only limited drilling of openings in a vehicle structure, such as to receive a fastener in the transformed configuration. However, such drilling of openings does not prevent the structure from being converted or transformed back into a previous configuration.

The conversion of the vehicle from and/or between a first configuration and a second configuration according to these teachings may be accomplished or achieved by using non-permanent mechanical connections (e.g., mechanical fasteners, mechanical interlocks, bolts, screws, weld nuts, clamps, and/or friction fits). In this way, the reconfiguration may not permanently alter any of the vehicle components such that the vehicle components could not be returned to the previous configuration.

Advantageously, by utilizing non-permanent mechanical connections to add, remove, or reposition vehicle components during the reconfiguration or conversion, end users without access to complicated tools, machinery, and/or fabricating techniques can reconfigured the vehicle. Instead, common tool such as sockets, ratchets, wrenches, screw drivers, and the like can be used to reconfigure the vehicle, without the need for complicated and expensive tools, machinery, and/or fabricating techniques, such as, for example grinders, cutters, welders, etc.

The conversion of the vehicle from the first configuration to the second configuration may be performed after the vehicle has been placed in service by the original equipment manufacturer (OEM) In other words, the OEM may manufacture and offer the vehicle for sale in the first vehicle configuration as original equipment. Then, if a user desires the second vehicle configuration, the user may obtain the rear enclosure assembly and reconfigure the vehicle structure from the original equipment into the second vehicle configuration according to these teachings. The user can also reconfigure the vehicle back to the first vehicle configuration at a later time due to the reversibly configurable nature of the vehicle according to these teachings.

In the context of the present description, “original equipment” includes automotive vehicles and their respective components in a state as assembled during the construction of the vehicles as new vehicles. In contrast, “aftermarket” equipment includes components made by the OEM or by another entity other than the OEM, which might be installed as replacements or enhancements after the car comes out of the OEM factory. Components of the present description may be provided as components of original equipment vehicle, and/or provided as aftermarket components for installation on an original equipment vehicle (optionally using at least some of the hardware provided in the original equipment vehicle).

In the context of the present description, one of the vehicle configurations (e.g., first vehicle configuration or second vehicle configuration) may be a truck or pickup truck configuration. In the context of the present description, the other vehicle configuration (e.g., first vehicle configuration or second vehicle configuration) may be a sport utility vehicle (SUV) configuration.

In the context of the present description, a “pickup truck” includes a vehicle that may be a light, medium-duty, or heavy-duty truck. The pickup truck configuration may include a vehicle having an enclosed cab, cockpit, or occupant compartment (for at least a driver and at least one other occupant) and an open cargo area, namely a bed, located in the rear portion of the vehicle and being operable for storing and/or transporting cargo. A pickup truck configuration may be a vehicle that does not include a C-pillar, e.g., does not include a C-pillar that defines part of a cab. A pickup truck configuration may be a vehicle that does not include a D-pillar. A pickup truck configuration may be a vehicle that has a removable bulk head panel and rear window or glass assembly that can be completely removed or separated from the vehicle. A pickup truck configuration does not include features of a minivan.

In the context of the present description, a “sport utility vehicle” includes a vehicle that may be a light, medium-duty or heavy-duty vehicle including an enclosed cab (for at least a driver and at least one and preferably a plurality of other occupants), a cargo area enclosed by an enclosure, and a space behind a driver seat for or providing additional passenger seating. Thus, a “sport utility vehicle” includes a vehicle that is configured to receive at least one rear seat, at least one seat belt, and at least one air bag (e.g., a side curtain airbag mounted in an upper part of the vehicle adjoining an edge portion of the vehicle roof). When the vehicle is converted into the SUV configuration, C-and D-pillars may be added.

The vehicle in accordance with the present teachings (e.g., pickup truck configuration; SUV configuration, or any other configuration) may include a suspension. The suspension may include a solid axle. The suspension may include a de Dion suspension or axle. The suspension may include coil springs. The coil springs may be located forward or rearward of the solid axle and not on the axle. he suspension may be free of any leaf springs. The suspension may include one or more end plates that are integrally formed with the solid axle. The suspension may include a half shaft that extends from the one or more motors through an opening in the end plate.

The vehicle may include a front wheel drive system, a rear wheel drive system, or a combination of front and rear wheel drive (e.g., all-wheel drive system). As part of the reconfiguration, the vehicle may be converted from a rear wheel drive system to a wrong wheel drive system and/or to an all-wheel drive system.

The vehicle disclosed herein may be powered by an electrified powertrain (e.g., it is free of an internal combustion engine). An electrified powertrain may comprise one or more batteries. The one or more batteries may be chargeable by plugging the vehicle into a charging station and/or with regenerative features while the vehicle is in operation. The vehicle may include one or more wheel corner assemblies that include regenerative braking systems. The vehicle may include a front-wheel drive powertrain, a rear-wheel drive powertrain, or an all-wheel drive powertrain. A factory model of the vehicle may include rear-wheel drive or front-wheel drive, and an end user may install an additional motor or powertrain in the vehicle to convert the vehicle into all-wheel drive. The vehicle may comprise one or more motors, hardware, and/or software that allows for a plug-and-play integration when the powertrain is added or converted from front-wheel drive to rear-wheel drive and/or all-wheel drive, or from rear-wheel drive to front-wheel drive and/or all-wheel drive.

### Audio System

The audio system may comprise a plurality of speaker units. The plurality of speaker units may be operable in a vehicle. One or more of the speaker units may operate apart from the vehicle. That is, function as a portable speaker. The plurality of speaker units may be locatable in various positions in the vehicle to deliver sound to front and rear seating rows, provide surround sound, or both.

The audio system may be comprised by a reconfigurable vehicle as described herein. The reconfigurable vehicle may be an electric vehicle. In this regard, a user may install as many speaker units as desired, or as can be accommodated by a particular vehicle configuration. By way of one example, in a truck configuration, rear seating and/or doors may be removed from the vehicle and only front seating may remain. In this configuration, speaker units in the front occupant space may be employed. By way of another example, in an SUV configuration, rear seating and/or doors may be present and speaker units in the front and rear occupant spaces may be employed. By way of yet another example, in order to save on costs, the user may decide to forego a multi-unit audio system, and rather operate a single speaker unit. Said single speaker unit may be locatable on mounting points provided throughout the vehicle. As will be discussed, such mounting points may be in the form of channels. An exemplary channel may be in the form of a T-rail.

The vehicle may comprise one or more wiring harnesses. The one or more wiring harnesses may be adapted and configured to respectively connect to one or more speaker units. Preferably, first speaker units as described herein. The one or more wiring harnesses may include connections for signal communication, power transmission, or both. Preferably, at least signal communication.

The speaker units may include one or more first speaker units. The first speaker units may be locatable in a front occupant space. The first speaker units may be located in an instrument panel. The one or more first speaker units may include at least a driver speaker unit. The first speaker units may include one or more auxiliary speaker units.

The speaker units may include one or more second speaker units. The second speaker units may be locatable in a rear occupant space and/or a front occupant space. The one or more second speaker units may include a center mounted speaker unit, a left mounted speaker unit, a right mounted speaker unit, or any combination thereof. The center mounted speaker unit may be located on the instrument panel. The left and right mounted speaker units may be respectively located on left and right rear doors of the vehicle.

The speaker units may include one or more batteries. The speaker units may include a power input for an external power source. The external power source may be a vehicle-borne power source (e.g., an automotive battery and/or an electric vehicle battery). The speaker units may include one or more wireless network modules. Wireless network modules, as referred to herein, may be adapted and configured to communicate via a cellular network, a network operating under the IEEE 802.11 standards, a short-range network operating in the 2.402 GHz to 2.48 GHz frequency bands, a GPS network, a network operating under the SKAA protocol, or any combination thereof. A combination of the foregoing features may be embodied by one or more speaker units.

One or more of the second speaker units may include a battery. The battery may be an internal battery, such as an internal rechargeable battery. One or more of the second speaker units may include a power input for an external power source. The external power source may be a vehicle-borne power source (e.g., an automotive battery and/or an electric vehicle battery). The power input may be complementary with one or more power outputs of channels described herein. One or more of the second speaker units may include a battery and a power input for an external power source.

The power input/output may be in the form of induction elements, surface contacts, or both. The induction elements may be in the form of coils. A first coil in a speaker unit may electrically interact with a second coil in a vehicle (e.g., in a channel described herein). The surface contacts may be electrically conductive elements. First surface contacts in a speaker unit may be placed into and out of contact with surface contacts in a vehicle (e.g., in a channel described herein).

The second speaker units may include a wireless network module. The driver speaker unit may include a wireless network module. The driver speaker unit may wirelessly communicate audio signals to the one or more second speaker units. Control signals may be communicated between the wireless network module and the driver speaker unit. The driver speaker unit may comprise a subwoofer.

The driver speaker unit may include a power input for an external power source. The external power source may be a vehicle-borne power source (e.g., an automotive battery and/or an electric vehicle battery). The driver speaker unit may wirelessly communicate audio signals to the one or more second speaker units.

The one or more first speaker units may include one or more auxiliary speaker units. The one or more auxiliary speaker units may include a left auxiliary speaker unit, a right auxiliary speaker unit, or both. The driver speaker unit may communicate audio signals to the one or more auxiliary speaker units. The driver speaker unit may communicate via a wired and/or a wireless connection.

The one or more auxiliary speaker units may include a power input for the external power source. The external power source may be a vehicle-borne power source (e.g., an automotive battery and/or an electric vehicle battery). The one or more auxiliary speaker units may be free of an external power source.

The one or more auxiliary speaker units, the driver speaker unit, or both may comprise an on-board amplifier. The amplifier may be on-board speaker units comprising a power input or an on-board battery.

The audio system may comprise one or more audio endpoints. The one or more audio endpoints may signally communicate (e.g., via a wired or wireless connection) with the driver speaker unit, control operation of the audio system, or both. The audio endpoint may be a mobile device. The mobile device may be a smartphone, a tablet, a laptop computer, or a smart wearable (e.g., a smart watch). The audio endpoint may signally communicate with a driver speaker unit. Such communication may be via a wired connection or wireless network modules.

### Instrument Panel

The vehicle may comprise an instrument panel. The instrument panel may comprise one or more bins. The bins may be regions defined in the instrument panel which may be used for storage, receiving speaker units, or both.

The instrument panel may comprise one or more cradles. The one or more cradles may function to receive speaker units. The one or more cradles may be located in one or more of the bins. The one or more cradles may include a flange that engages one or more lips of the one or more bins. The one or more cradles may include through-holes on the flange for fastening the one or more cradles to the one or more bins. The one or more cradles may include an open end adapted and configured for locating a wiring harness through. The one or more cradles may include a recess in which a flange of a speaker unit locates and upon which the speaker unit may be supported.

The instrument panel may include one or more doors and/or covers for covering the one or more bins. The one or more doors and/or covers may be adapted and configured to be at least partially acoustically transparent. The one or more doors and/or covers may comprise a base, a substrate, and a scrim material.

The base and the substrate may comprise holes, which contribute to the acoustic transparency thereof. The holes of the base may be larger in area compared to the holes of the substrate, or vice versa. The scrim material may be a fabric.

The one or more the doors and/or covers may comprise a lock mechanism. Part of the lock mechanism may be located on the instrument panel. Part of the lock mechanism may be located on the door or cover. The lock mechanism may be modular with respect to the instrument panel.

The base may form a hinged engagement with the instrument panel. In one exemplary aspect, the base may comprise opposing hinge arms and pins thereon which form a hinged engagement with the instrument panel. In another exemplary aspect, the base may comprise a flap connected thereto by a living hinge, and the flap may be connected to the instrument panel.

The one or more the doors and/or covers may be comprised by a reconfigurable vehicle as described herein. The reconfigurable vehicle may be an electric vehicle.

The vehicle may comprise one or more channels. The one or more channels may function to mate with one or more speaker units. The one or more channels may be in the form of T-rails.

The one or more channels may include a first channel located on an instrument panel. The channel may be located below a control cluster (e.g., a climate control cluster).

The one or more channels may include one or more second channels located on one or more doors of the vehicle. Preferably the channels are located on left and right rear doors.

The one or more channels may include one or more third channels located on a B-pillar of the vehicle.

The one or more channels may include an inductive charging mechanism, surface contacts, or both, as described herein. The inductive charging mechanism and the surface contacts may be connected to a vehicle-borne power source.

The channels may be comprised by a reconfigurable vehicle as described herein. The reconfigurable vehicle may be an electric vehicle.

### Speaker Holder

The speaker holder may comprise a first segment and a second segment. The first and second segments may be slidably adjustable relative to each other. The first and second segments may define a region therebetween adapted and configured to accept a speaker unit. The speaker holder may have a cross-sectional profile that is generally polygonal with radiused corners.

Each of the first and second segments may comprise a curved lip defining a space through which a speaker unit passes to become engaged with the speaker holder.

The first and second segments may comprise a fastening mechanism to set a position of the first segment relative to the second segment; and wherein the fastening mechanism includes a screw, a compression latch, or both.

The first and second segments may each have overlapping portions. That is, a portion of the first segment may overlap a portion of the second segment, or vice versa. The overlapping portions may be in opposing relationship to an opening through when a speaker unit is introduced into the speaker holder. The overlapping portions may be in opposing relationship to the curved lips.

The first and/or second segments may comprise a plurality of holes adapted and configured to permit sound to pass through. The plurality of holes may be in the form of squircles.

The first and/or second segments comprise one or more gripping elements. The one or more gripping elements may contact a speaker unit. The one or more gripping elements may be fabricated from a grip material.

The first and/or second segments may comprise one or more engagement features. The one or more engagement feature may be configured to be accepted within the one or more channels. The one or more channels may be in the form of T-rails. The engagement features may be in the form of clips. The clips may form a snap-fit with the T-rail.

The speaker holder may comprise a strap and buckle that connects at one end to the first segment and at an opposing end to the second segment. The strap and buckle may function to retain a speaker unit within the speaker holder.

The first and/or second segments may be fabricated from ABS, optionally filled with a fiber (e.g., a glass fiber).

The speaker holder may be comprised by a reconfigurable vehicle as described herein. The reconfigurable vehicle may be an electric vehicle.

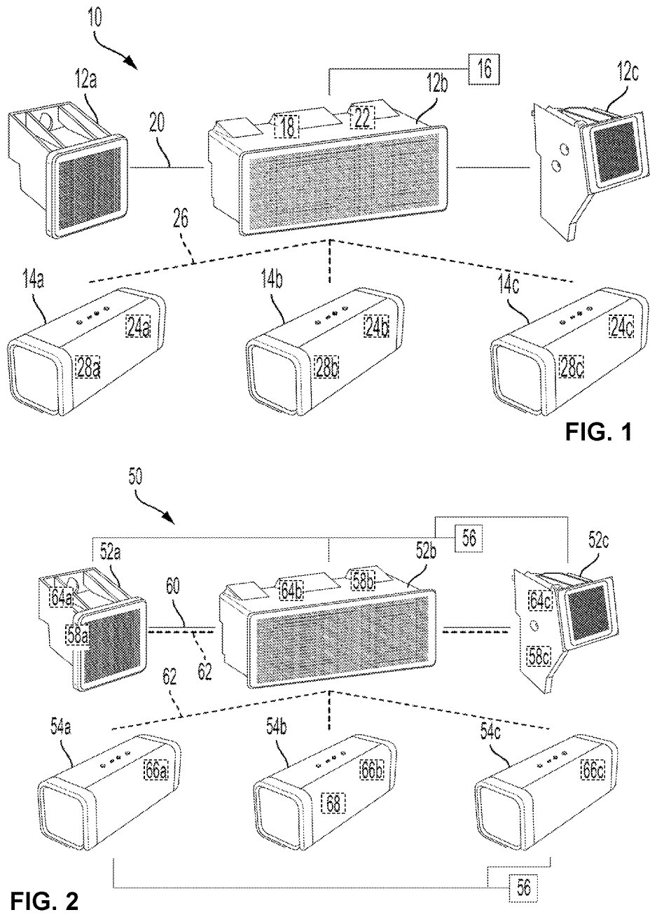

FIG. 1 illustrates an exemplary audio system 10 comprising first speaker units 12a-12c and second speaker units 14a-14c. The speaker unit 12b is a driver speaker unit as described herein. The driver speaker unit 12b is connected to an external power source 16. The driver speaker unit 12b has an amplifier 18 (e.g., a 6-channel amplifier, such as the VX600/6i). that is powered by the external power source 16. The speaker units 12a, 12c have a wired connection 20 to the speaker unit 12b by which audio signals are communicated.

The driver speaker unit 12b includes a wireless network module 22. Each of the second speaker units 14a-14c include wireless network modules 24a-24c, which receive audio signals from the wireless network module 22 of the driver speaker unit 12b, via a wireless connection 26. Each of the second speaker units 14a-14c include batteries 28a-28c.

FIG. 2 illustrates an exemplary audio system 50 comprising first speaker units 52a-52c and second speaker units 54a-54c. The speaker unit 52b is a driver speaker unit as described herein. The first speaker units 52a-52c are connected to an external power source 56. The first speaker units 52a-52c each have an amplifier 58a-58c that are powered by the external power source 56. The speaker units 52a, 52c have a wired connection 60 to the speaker unit 12b and a wireless connection 62 via respective wireless network modules 64a-64c. Audio signals may be communicated via the wired and/or wireless connection 60, 62.

Each of the second speaker units 54a-54c include wireless network modules 66a-66c, which receive audio signals from the wireless network module 64b of the driver speaker unit 52b, via a wireless connection 62. It is also envisioned that the audio signals may be communicated from the wireless network modules 64a, 64c of the first speaker units 52a, 52c. The second speaker unit 54b includes a battery 68. The second speaker units 54a, 54c are connected to the external power source 56.

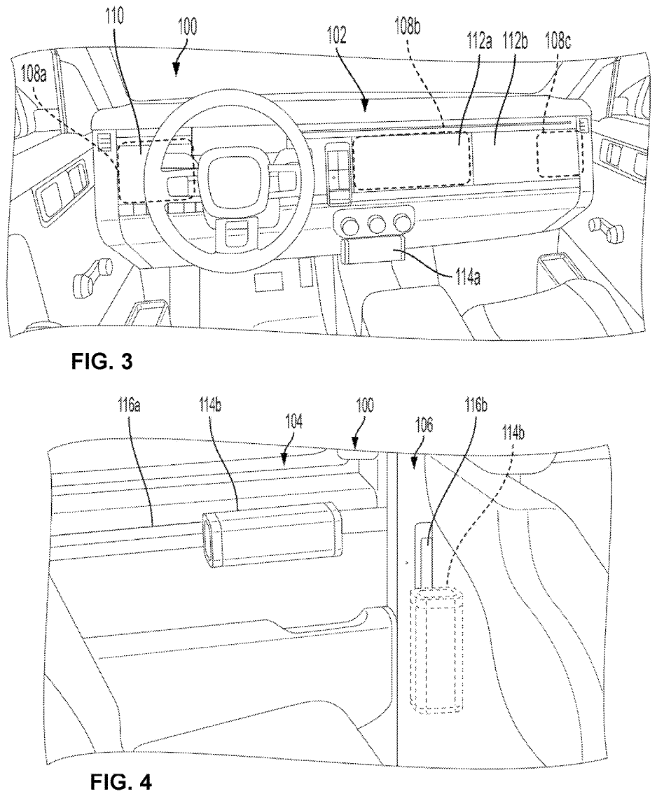

FIG. 3 and FIG. 4 illustrate an exemplary vehicle 100. The vehicle 100 comprises an instrument panel 102, a door 104, and a B-pillar 106.

First speaker units 108a-108c are located in the instrument panel 102. As will be discussed, the first speaker units 108a-108c may be locatable in bins described herein. The first speaker unit 108a is located behind a cover 110 and the first speaker units 108b, 108c are located behind doors 112a, 112b, as described herein.

A second speaker unit 114a is located on the instrument panel 102. The second speaker unit 114a connects to a channel (not shown; e.g., in the form of a T-rail) located on the instrument panel 102. A second speaker unit 114b is locatable on the door 104 or the B-pillar 106. The second speaker unit 114b connects to channels 116a, 116b (e.g., in the form of T-rails) respectively located on the door 104 and the B-pillar 106. The channel 116a may be used in an SUV configuration of the vehicle 100 as described herein and the channel 116b may be used in a truck configuration of the vehicle 100 as described herein, although the present teachings are not intended to be limited to this arrangement. It is understood that the configurations shown in FIG. 4, which illustrates a driver side of the vehicle 100, can be mirrored on the passenger side of the vehicle 100.

The present teachings contemplate that the channel 116a, the channel 116b, the channel (not shown) located on the instrument panel 102, or any combination thereof may comprise one or more pins or bars. The one or more pins or bars may be electrically conductive. The one or more pins or bars may be configured and adapted for providing power to a speaker unit engaged with the channel. The one or more pins or bars may form an electrical connection with complementary pins located on the speaker unit.

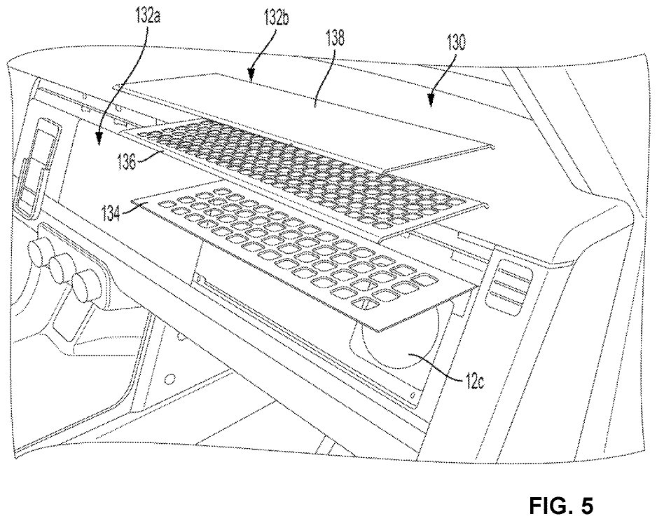

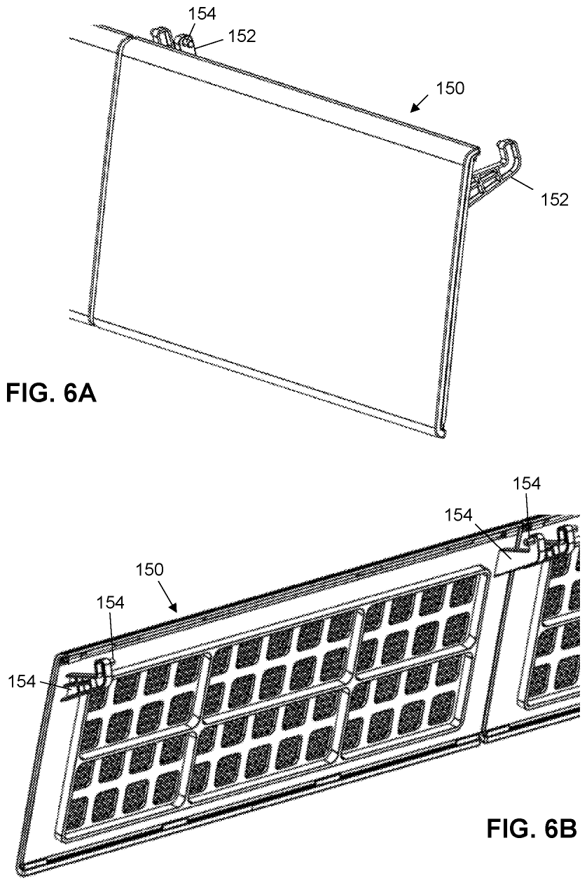

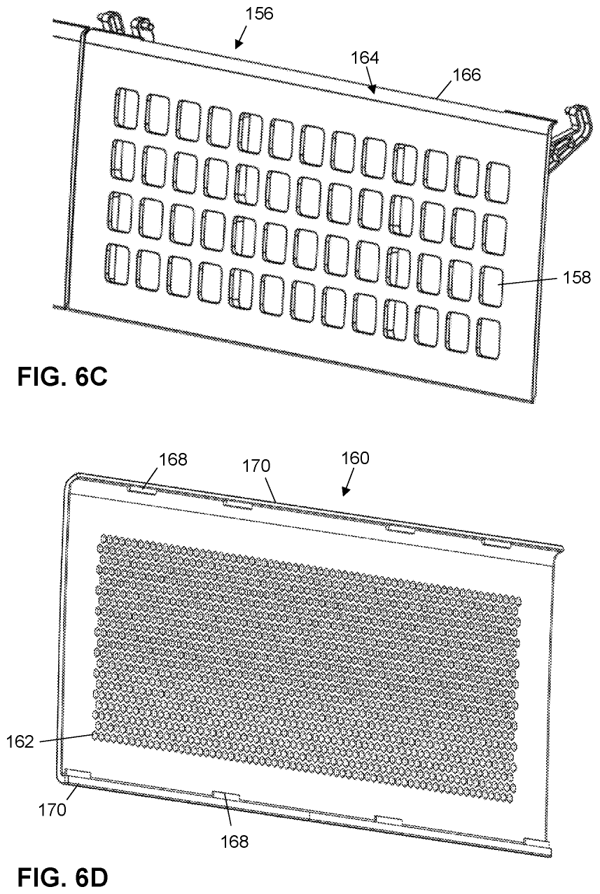

FIG. 5 illustrates an instrument panel 130. The instrument panel 130 includes doors 132a, 132b. Each of the doors 132a, 132b comprise a three-layer construction. A base 134, which is perforated, provides a rigid structure. A substrate 136 is connected to the base 134. The substrate 136 defines tabs (see, e.g., FIG. 6D) on opposing edges thereof, which form a snap-fit onto the base 134. A scrim 138 is connected (e.g., chemically adhered) to the substrate 136.

The base 134, substrate 136, and scrim 138 and may be acoustically transparent or at least substantially acoustically transparent (e.g., about 80% acoustically transparent or more, about 85% acoustically transparent or more, about 90% acoustically transparent or more, or even about 95% acoustically transparent or more). The base 134, the substrate 136, or both may be perforated, to allow sound to pass through. The holes of the base 134 may or may not have one or more dimensions in common with the holes of the of the substrate 136. The scrim 138 may be constructed of one or more layers of mesh, or a fabric having an open weave. The base 134, the substrate 134, or both may be fabricated from a polymer. The polymer may include polypropylene.

FIG. 6A through FIG. 6D illustrate a door 150. The door 150 includes hinge arms 152. The hinge arms 152 each include a pin 154 oriented toward each other. The pins 154 are adapted and configured to engage with an instrument panel, such as shown in FIG. 5. The door 150 is adapted and configured to be removable, without destruction or plastic deformation of the door 150 or the instrument panel. In this regard, the door 150 may be interchanged. The base 156 of the door 150 includes holes 158 and the substrate 160 of the door 150 includes holes 162, both of which cooperate to allow sound to pass through the door 150, and so a speaker unit located in the instrument panel operate while the door 150 is closed. The holes 158 of the base 156 are larger than the holes 162 of the substrate 160.

The base 156 has two opposing edges each comprising a curved lip 164. Each curved lip 164 includes a cutout 166, which receives tabs 168 that snap-fit onto the base 156. The substrate 160 has two opposing edges each comprising a curved lip 170, and the tabs 168 extend therefrom. The substrate 160 can be pressed onto the base 156, the substrate 160 may exhibit a degree of flexure, and the tabs 168 pass through the cutouts 166 and snap-fit onto the base 156.

The scrim of the door shown in FIG. 5 is adhered (e.g., chemically adhered) to the substrate. The present teachings contemplate that the scrim can be adhered or otherwise connected to the base, without the substrate.

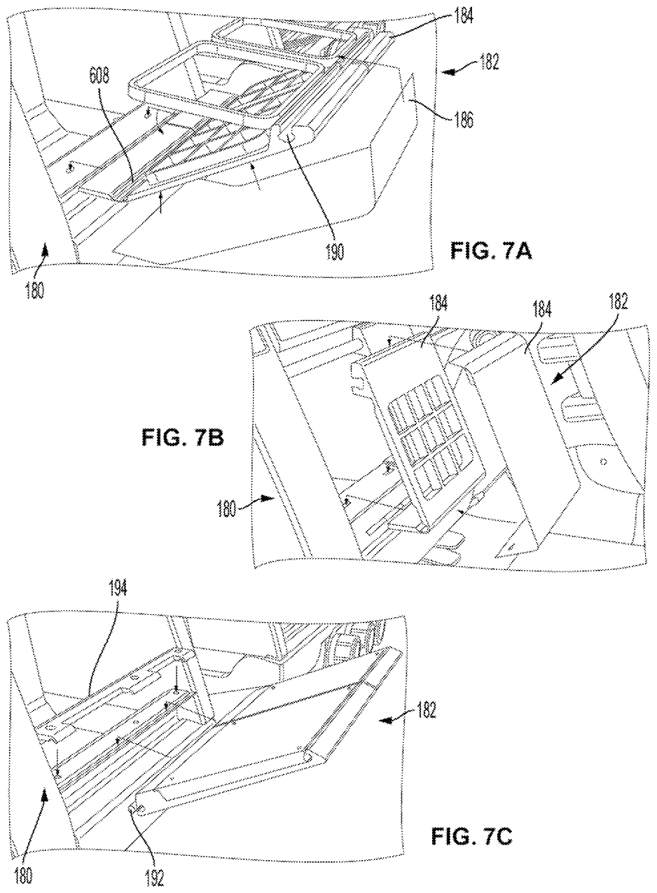

FIG. 7A through FIG. 7C illustrate other exemplary instrument panels 180 and doors 182 thereof. FIG. 7A and FIG. 7B show a door 182 comprising a base 184 and a scrim 186. The scrim 186 is wrapped around the base 184 and can be affixed to the base 184 by being sandwiched between a hinge 188 (e.g., a compliant hinge) and the instrument panel 180 upon which the hinge 188 is affixed. Fasteners extending from the hinge 188 (e.g., clips) and that insert into corresponding holes in the instrument panel 180 may extend through cutouts in the scrim 186. An opposing end of the scrim 186 is located into a channel 190 thereof. It is envisioned that the scrim 186 may also be adhered (e.g., chemically adhered) to the base 184.

FIG. 7C shows a base 184 that includes a hinge 188 in the form of a pin 192 that is sandwiched between a plate 194 and the instrument panel 180.

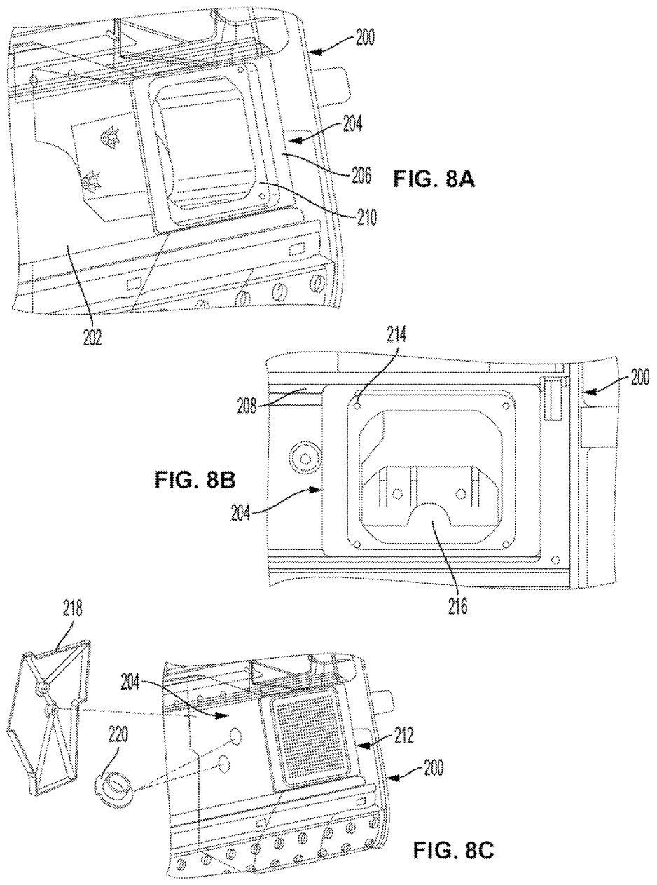

FIG. 8A through FIG. 8C illustrate an instrument panel 200. The instrument panel 200 defines bins 102 which may function as a storage space and to house speaker units described herein. The instrument panel 200 comprises a cradle 204 located in the bin 202. The cradle 204 includes a flange 206 that rests upon a lip 208 of the bin 202. The cradle 204 has a recess 210 offset from the flange 206 and into which a speaker unit 212 fits. The mating relationship of the cradle 204 with the bin 202, and the bin 202 with the speaker unit 212 is such that an outward-facing surface of the speaker unit 212 is flush or generally flush with the opening of the bin 202. The cradle 204 has holes 214 formed within the recess 210 such that fasteners (not shown) can extend through the speaker unit 212 and into the holes 214 to secure the speaker unit 212 to the cradle 204. It is contemplated the fasteners can also extend into and engage the instrument panel 200 (e.g., the lip 208). If a speaker unit 212 is not installed in the cradle 204, a cover (not shown) can be secured to the cradle 204 in the same manner.

The cradle 204 has an access port 216 through which a wiring harness (not shown) can be accessed. The wiring harness may provide for power, signal communication for audio signals, or both. Thus, upon installation, the wiring harness can first be connected to the speaker unit 212 and then the speaker unit 212 can be located into the cradle 204. The cradle 204 has a cover panel 218 that extends over and covers the open space underneath the cradle 204, and which can be removed to provide better access to wiring or otherwise for installing the speaker unit 212. Fasteners applied to the cover panel 218 can be covered by caps 220.

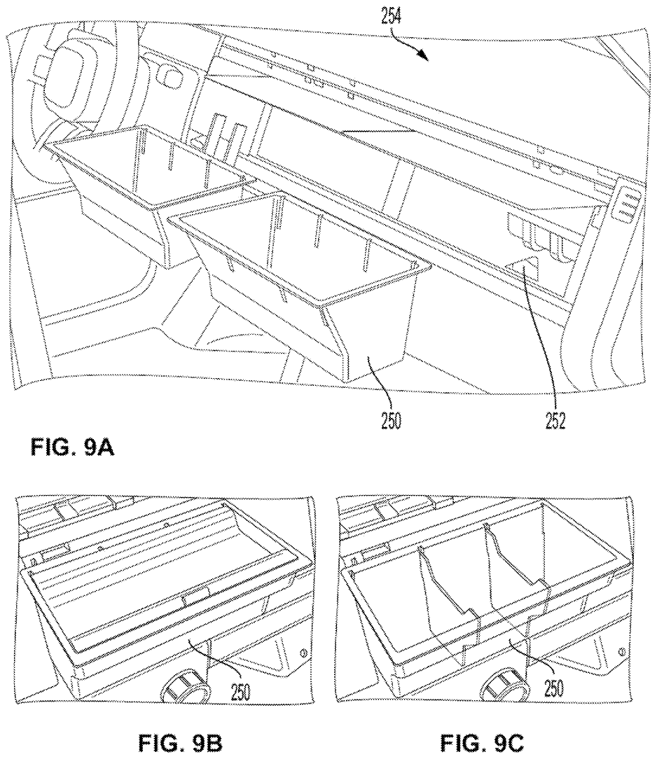

FIG. 9A through FIG. 9C illustrate exemplary bin inserts 250, which locate into the bin 252 of an instrument panel 254. The bin inserts 250 function as receptacles and close the open bottom of the bin 252.

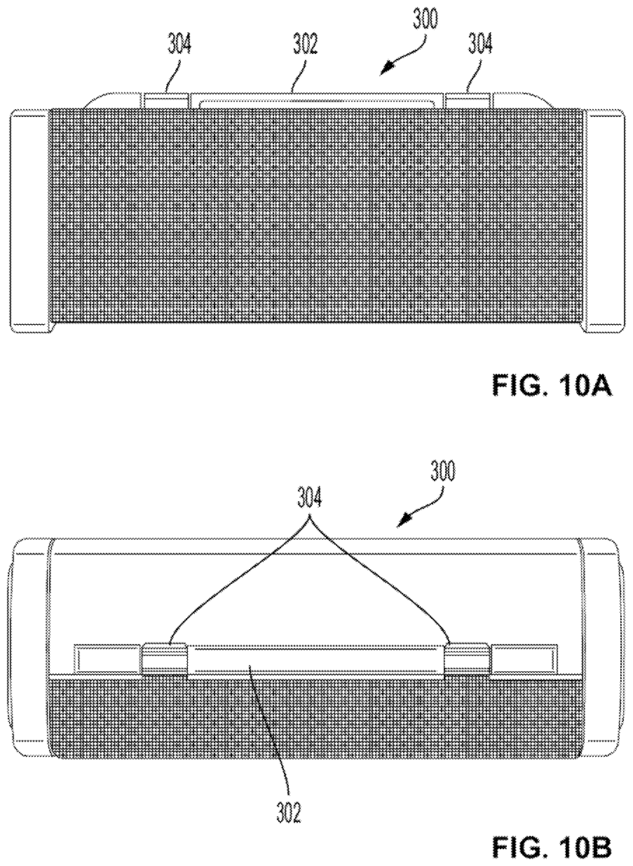

FIG. 10A and FIG. 10B illustrate a speaker unit 300. The speaker unit 300 comprises a rib 302 and two clips 304 in-line with the rib 302. The rib 302 and clips 304 are adapted and configured to be received in a channel (e.g., any one of the channels described in FIG. 3 and FIG. 4).

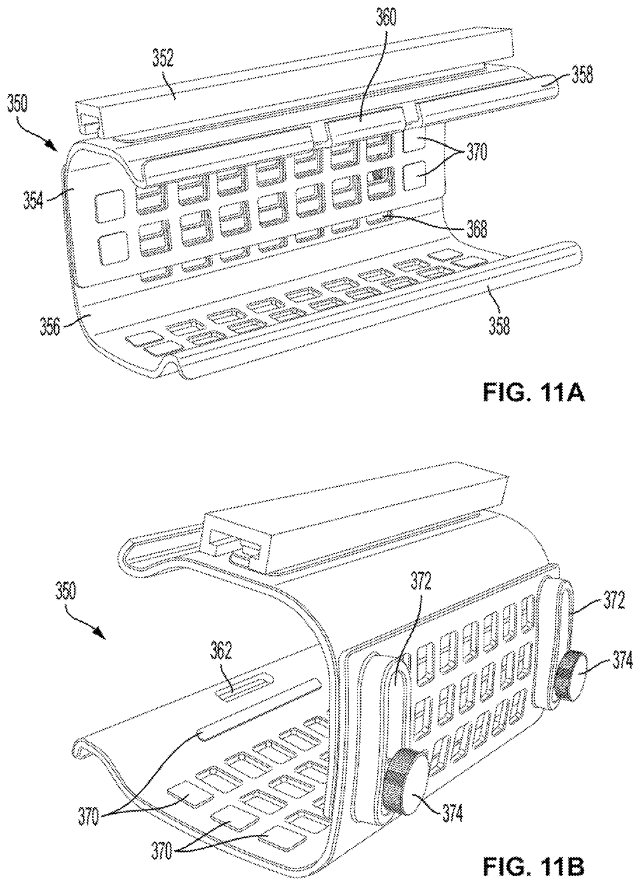

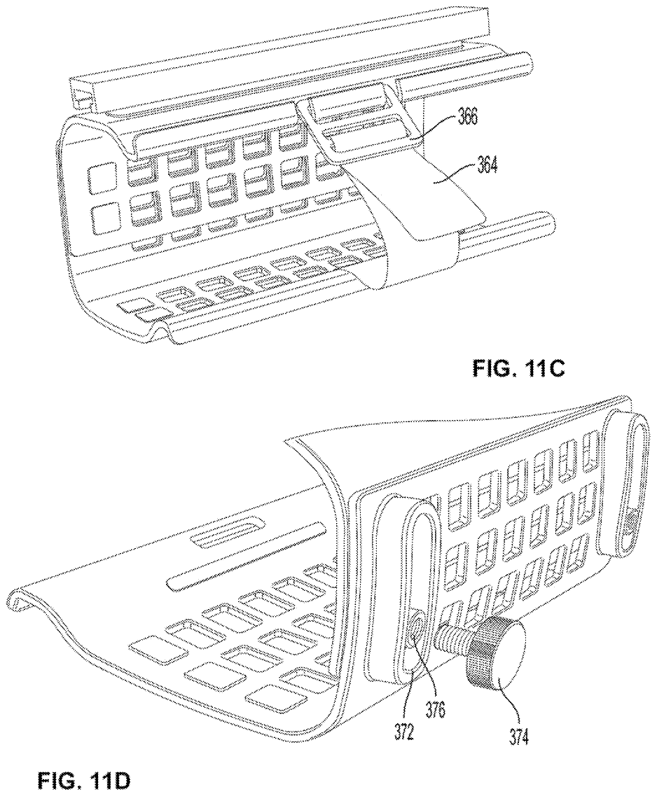

FIG. 11A through FIG. 11D illustrate a speaker holder 350. The speaker holder 350 is adapted and configured to hold a speaker unit, such as but not limited to those described herein. The speaker holder 350 is connected to a channel 352 (e.g., any one of the channels described in FIG. 3 and FIG. 4). It is envisioned that the channel 352 can be connected to an instrument panel, a door, a B-pillar, or any combination thereof, as described herein.

The speaker holder 350 comprises a first segment 354 and a second segment 356. The first and second segments 354, 356 are adjustable relative to each other, in order to adjust to cooperate with the size of the speaker unit to be held in the speaker holder 350. The first and second segments 354, 356 define a cross-sectional profile of the speaker holder 350 that is generally polygonal with radiused corners. In this regard, it has been found that this profile is suitable for securing a variety of commercially available speaker units.

The first and second segments 354, 356 each comprise a curved lip 358. The curved lip 358 assists with accepting a speaker unit, generally funneling the speaker unit into the region between the first and second segments 354, 356. The first and second segments 354, 356 are suitably ductile to elastically deform and snap-fit over the speaker unit, and hold the speaker unit under a clamp load. The speaker holder 350 may be fabricated from a acrylonitrile butadiene styrene (ABS) polymer or other suitable polymer.

Moreover, the curved lips 358 define a hook 360 and a slot 362 for a strap 364 with a buckle 366 to be engaged. Although, the present teachings contemplate other fasteners, such as a compression latch.

The first and second segments 354, 356 further comprise holes 368 adapted and configured to allow sound to pass through. As speaker units can have speakers on one or multiple sides thereof, the holes 368 can provide for adequate audio performance without the need for precise positioning or orienting of speaker units within the speaker holder 350.

The first and second segments 354, 356 further comprise gripping elements 370 for gripping onto the speaker unit. Exemplary gripping elements may be fabricated from a rubber. In one exemplary aspect, the gripping elements 370 may be overmolded in a 2-shot molding process.

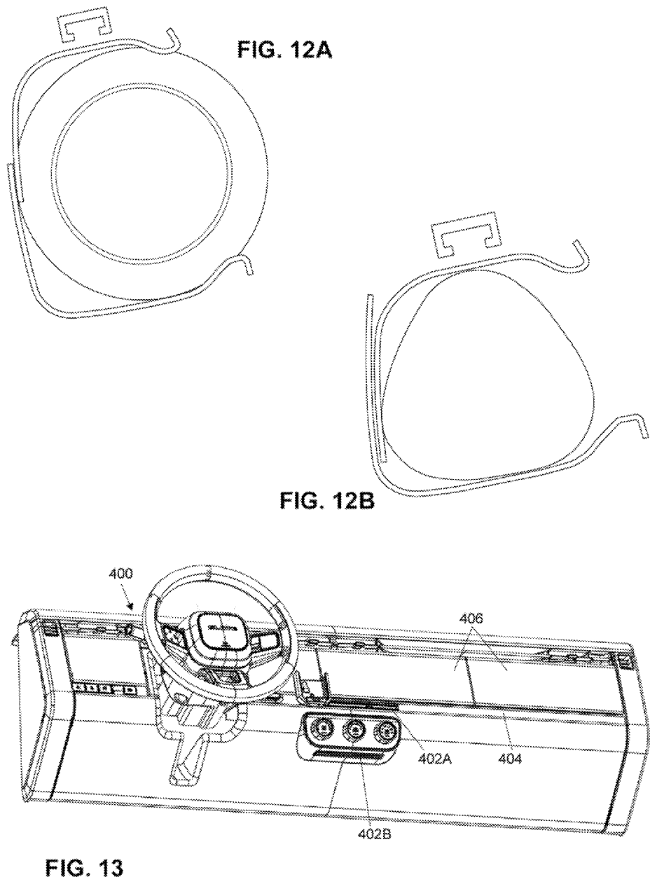

The second segment 356 includes two tracks 372 through which screws 374 can extend and thread into the first segment 354. The first segment 354 includes posts 376 that are internally threaded to receive the screws 374 and which respectively locate in the tracks 372. The screws 374 have enlarged heads that prevent separation of the first and second segments 354, 356 at least prior to complete removal of the screws 374. The screws 374 may be loosened to allow adjustment of the first segment 354 relative to the second segment 356, to manipulate one or more dimensions of the region therebetween. In this regard, the speaker holder 350 may accept various configurations of speaker units, such as shown in FIG. 12A and FIG. 12B.

FIG. 13 illustrates an exemplary instrument panel 400 according to the present teachings. The instrument panel 400 includes channels 402A, 402B, in the form of T-rails, to which accessories (e.g., a speaker and/or a speaker holder) can connect. One channel 402A is located above the climate control cluster, and another channel 402B is located below the climate control cluster. The instrument panel 400 further includes a recess (not shown) occupied by a cover 404, located below doors 406 of the instrument panel 400, described below.

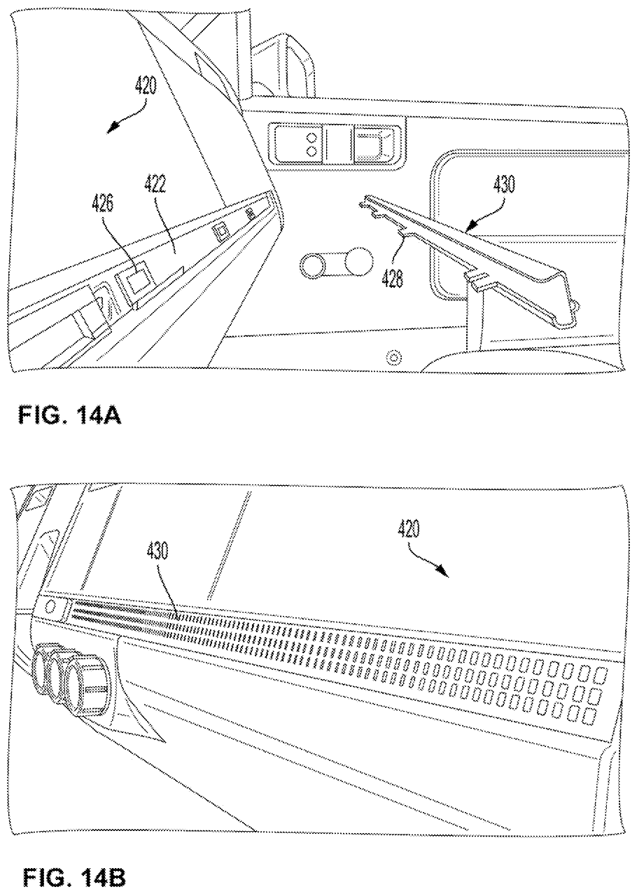

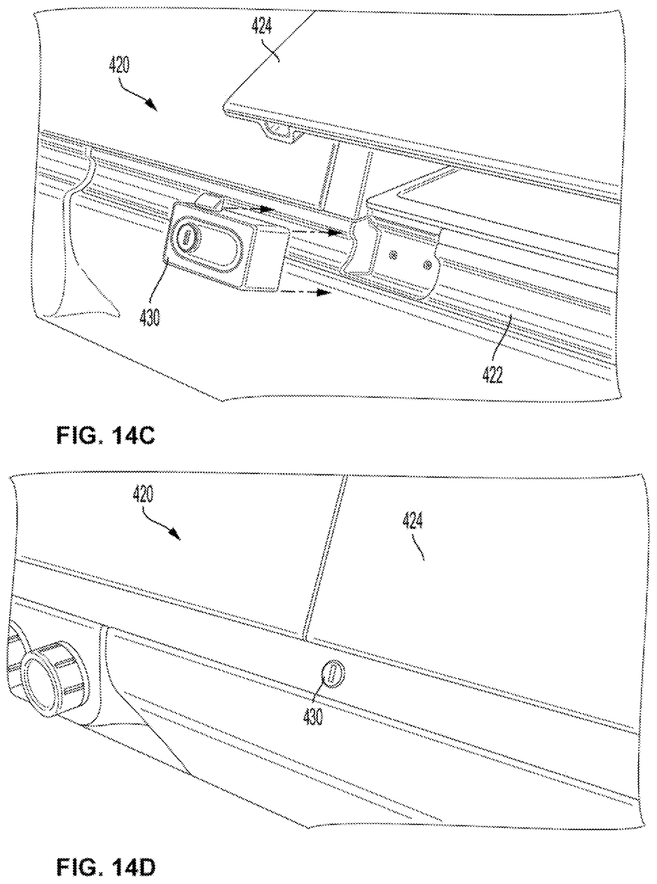

FIG. 14A through FIG. 14D illustrate an exemplary instrument panel 420. The instrument panel 420 comprises a recess 422 located below the doors 424 thereof. The recess 422 includes mating features 426 adapted and configured to receive fasteners 428 (e.g., clips) of an accessory 430. The accessory 430 is adapted and configured to fit within the recess 422. The accessory 430 comprises a first side functioning as a facia for the instrument panel 420, and optionally for other purposes (e.g., providing a keyway for a lock), and an opposing second side comprising the fasteners 428. The fasteners 428 may be adapted and configured for repeated installation and removal. Removal may be achieved without damage or plastic deformation to the cover accessory 430 or the instrument panel 420.

The accessory 430 illustrated in FIG. 14A and FIG. 14B is in the form of a cover. The accessory 430 illustrated in FIG. 14C and FIG. 14D is in the form of a lock, which engages and selectively locs the door 424.

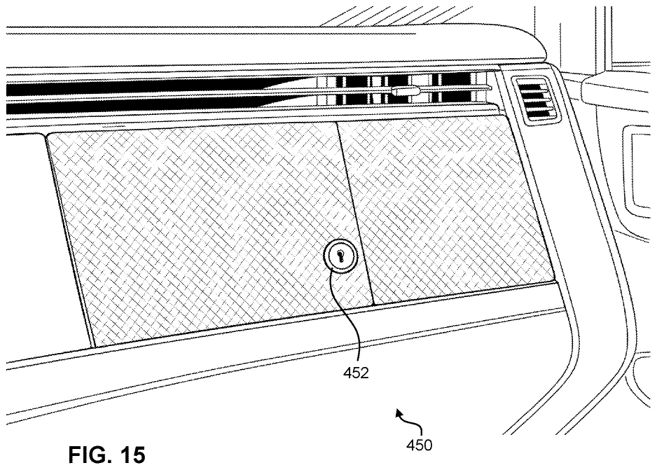

FIG. 15 illustrates another exemplary door 450 with an integrated lock 452.

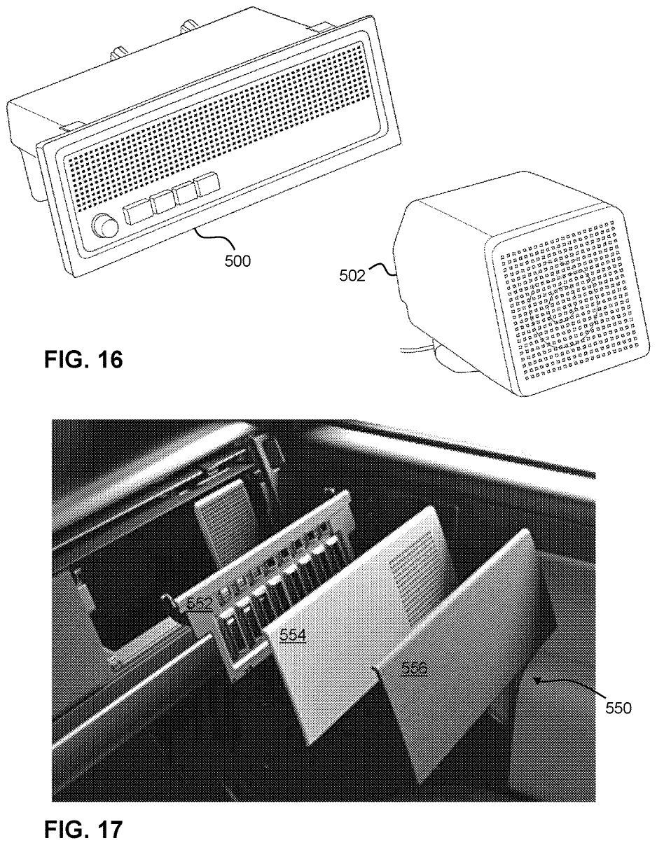

FIG. 16 illustrates other exemplary speaker units 500, 502.

FIG. 17 illustrates another exemplary door 550 comprising a base 552, a substrate 554, and a scrim 556. The substrate 554 comprises holes in a region thereof that is juxtaposed with a speaker unit in the instrument panel, and is solid elsewhere. The base 552 comprises holes larger in dimension than the holes of the substrate 554, and distributed across substantially the length of the base 552.

It is understood that the above description is intended to be illustrative and not restrictive. The explanations and illustrations presented herein are intended to acquaint others skilled in the art with the invention, its principles, and its practical application.

Those skilled in the art may adapt and apply the invention in its numerous forms, as may be best suited to the requirements of a particular use. Many embodiments as well as many applications besides the examples provided herein will be apparent to those of skill in the art upon reading the above description.

Accordingly, the specific embodiments of the invention set forth herein are not intended as being exhaustive or limiting of the teachings. The scope of the invention should, therefore, be determined not with reference to the above description, but should instead be determined with reference to the appended claims, along with the full scope of equivalents to which such claims are entitled.

The omission in the following claims of any aspect of subject matter that is disclosed herein is not a disclaimer of such subject matter, nor should it be regarded that the inventors did not consider such subject matter to be part of the disclosed inventive subject matter.

The disclosures of all articles and references, including patent applications and publications, are incorporated by reference for all purposes.

Plural elements or steps can be provided by a single integrated element or step. Alternatively, a single element or step might be divided into separate plural elements or steps.

The disclosure of “a” or “one” to describe an element or step is not intended to foreclose additional elements or steps.

The use of “about” or “approximately” in connection with a range applies to both ends of the range. Thus, “about 20 to 30” is intended to cover “about 20 to about 30”, inclusive of at least the specified endpoints.

Unless otherwise stated, all ranges include both endpoints and all numbers between the endpoints in increments of one unit provided that there is a separation of at least 2 units between any lower endpoint and any higher endpoint. As an example, if it is stated that the amount of a component, a property, or a value of a process variable such as, e.g., temperature, pressure, time, and the like is, e.g., from 1 to 90, from 20 to 80, or from 30 to 70, it is intended that intermediate range values such as, e.g., 15 to 85, 22 to 68, 43 to 51, 30 to 32, etc., are within the teachings of this specification. Likewise, individual intermediate values are also within the present teachings. For values which are less than one, one unit is considered to be 0.0001, 0.001, 0.01, or 0.1 as appropriate. These are only examples of what is specifically intended and all possible combinations of numerical values between the lowest endpoint and the highest endpoint enumerated are to be considered to be expressly stated in this application in a similar manner.

The term “consisting essentially of” to describe a combination shall include the elements or components identified, and such other elements or components that do not materially affect the basic and novel characteristics of the combination. The use of the terms “comprising” or “including” to describe combinations of elements or components herein also contemplates embodiments that consist essentially of the elements or components.

While the terms first, second, third, etc., may be used herein to describe various elements, components, regions, layers, and/or sections, these elements, components, regions, layers, and/or sections should not be limited by these terms. These terms may be used to distinguish one element, component, region, layer, and/or section from another region, layer, and/or section. Terms such as “first,” “second,” and other numerical terms when used herein do not imply a sequence or order unless clearly indicated by the context. Thus, a first element, component, region, layer, and/or section discussed below could be termed a second element, component, region, layer, and/or section without departing from the teachings.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the drawings. Spatially relative terms may be intended to encompass different orientations of the device in use or operation in addition to the orientation depicted in the drawings. For example, if the device in the drawings is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The terms “generally” or “substantially” to describe angular measurements may mean about +/−10% or less, about +/−5°or less, or even about +/−1% or less. The terms “generally” or “substantially” to describe angular measurements may mean about +/−0.01% or greater, about +/−0.1% or greater, or even about +/−0.5% or greater.

The terms “generally” or “substantially” to describe linear measurements, percentages, or ratios may mean about +/−10% or less, about +/−5% or less, or even about +/−1% or less. The terms “generally” or “substantially” to describe linear measurements, percentages, or ratios may mean about +/−0.01% or greater, about +/−0.1% or greater, or even about +/−0.5% or greater.

### REFERENCE NUMERALS

10 audio system
12a first speaker unit
12b first speaker unit/driver speaker unit
12c first speaker unit
14a second speaker unit
14b second speaker unit
14c second speaker unit
16 external power source
18 amplifier
20 wired connection
22 wireless network module
24a wireless network module
24b wireless network module
24c wireless network module
26 wireless connection
28a battery
28b battery
28c battery
50 audio system
52a first speaker unit
52b first speaker unit/driver speaker unit
52c first speaker unit
54a second speaker unit
54b second speaker unit
54c second speaker unit
56 external power source
58a amplifier
58b amplifier
58c amplifier
60 wired connection
62 wireless connection
64a wireless network module
64b wireless network module
64c wireless network module
66a wireless network module
66b wireless network module
66c wireless network module
68 battery
100 vehicle
102 instrument panel
104 door
106 B-pillar
108a first speaker unit
108b first speaker unit/driver speaker unit
108c first speaker unit
110 cover
112a door
112b door
114a second speaker unit
114b second speaker unit
116a channel
116b channel
130 instrument panel
132a door
132b door
134 base
136 substrate
138 scrim
150 door
152 hinge arm
154 pin
156 base
158 holes
160 substrate
162 holes
164 curved lip
166 cutout
168 tab
170 curved lip
180 instrument panel
182 door
184 base
186 scrim
188 hinge
190 channel
192 pin
194 plate
200 instrument panel
202 bin
204 cradle
206 flange
208 lip
210 recess
212 speaker unit
214 holes
216 access port
218 cover panel
220 cap
250 bin insert
252 bin
254 instrument panel
300 speaker unit
302 rib
304 clip
350 speaker holder
352 channel
354 first segment
356 second segment
358 curved lip
360 hook
362 slot
364 strap
366 buckle
368 holes
370 gripping element
372 track
374 screw
376 post
400 instrument panel
402A channel
402B channel
404 cover
406 door
420 instrument panel
422 recess
424 door
426 mating feature
428 fastener
430 accessory
450 door
452 lock
500 speaker unit
502 speaker unit
550 door
552 base
554 substrate
556 scrim

What is claimed is:

1. An audio system for a vehicle, comprising:
a plurality of speaker units including:
at least one first speaker unit including:
a driver speaker unit which includes a power input for an external power source, a left auxiliary speaker unit and a right auxiliary speaker unit which signally communicates with the driver speaker unit via a wired or wireless connection; and
one or more second speaker units, at least one of which includes a battery (e.g., an internal battery, such as an internal rechargeable battery);
wherein the driver speaker unit wirelessly communicates audio signals to the at least one second speaker unit.

2. The audio system according to claim 1, wherein the one or more second speaker units include a center mounted speaker unit, a left mounted speaker unit, a right mounted speaker unit, or any combination thereof, preferably at least two of the foregoing.

3. The audio system according to claim 2, wherein the one or more second speaker units each include a wireless network module; and wherein the wireless network modules are adapted and configured to communicate according to SKAA, Bluetooth, Wi-Fi, or any combination thereof, preferably SKAA; and
wherein the driver speaker unit includes a wireless network module for wirelessly communicating the audio signals to the one or more second speaker units.

4. The audio system according to claim 3, wherein the one or more second speaker units includes two or more second speaker units adapted and configured to operate in surround sound.

5. The audio system according to claim 4, wherein the driver speaker unit and the one or more auxiliary speaker units are adapted and configured to operate in surround sound.

6. The audio system according to claim 5, wherein the one or more auxiliary speaker units include a power unput for the external power source; wherein the one or more auxiliary speaker units and the driver speaker unit comprises on-board amplifiers; and wherein the driver speaker unit comprises a subwoofer.

7. The audio system according to claim 5, wherein the one or more second speaker units include at least one second speaker unit having a power input for the external power source; wherein the external power source is a vehicle-borne power source; and optionally wherein the left mounted speaker unit and the right mounted speaker unit each have a power input for the external power source.

8. The audio system according to claim 7, further including an audio endpoint that signally communicates with the driver speaker unit and controls operation of the audio system; and wherein the audio endpoint is a mobile device.

9. A vehicle comprising the audio system according to claim 1, wherein the vehicle is an electric vehicle; and wherein the vehicle is a reconfigurable vehicle.

10. The vehicle according to claim 9, comprising a front occupant space and a rear occupant space; wherein the at least one first speaker unit is located in the front occupant space and at least one of the one or more second speaker units is located in the rear occupant space; wherein the at least one first speaker unit is located on or in an instrument panel of the vehicle; and wherein the center mounted speaker unit is located on the instrument panel and the left and right mounted speaker units are respectively located on left and right rear doors of the vehicle.

11. The vehicle according to claim 10, wherein the audio endpoint forms a wired connection with the vehicle and signally communicates with the driver speaker unit.

12. The vehicle according to claim 11, wherein the vehicle comprises one or more wiring harnesses; and wherein the one or more wiring harnesses are adapted and configured to connect to one or more of the at least one first speaker unit.

13. The vehicle according to claim 12, wherein the vehicle comprises induction contacts or surface contacts that form a conductive connection with the one or more second speaker units.

14. The vehicle according to claim 13, wherein the vehicle comprises T-rails on an instrument panel, one or more doors, one or both B-pillars, or any combination thereof; wherein a T-rail on the instrument panel is located below a climate control cluster; and wherein the induction contacts or surface contacts are located in the T-rails.

15. The vehicle according to claim 14, further comprising an instrument panel including one or more bins; and one or more cradles located in each of the one or more bins, and adapted and configured for receiving the one or more speaker units.

16. The vehicle according to claim 15, wherein the one or more cradles include a flange that engages one or more lips of the one or more bins; wherein the one or more cradles include through-holes on the flange for fastening the one or more cradles to the one or more bins; wherein the one or more cradles include a recess in which a flange of a speaker unit locates and upon which the speaker unit is supported; and wherein the one or more cradles include an open end adapted and configured for locating a wiring harness through.

17. The vehicle according to claim 16, wherein the instrument panel includes one or more doors and/or covers for covering the one or more bins, adapted and configured to be at least partially acoustically transparent; wherein the door and/or cover comprises: a base, a substrate, and a scrim material; wherein the base and the substrate comprise holes, which contribute to the acoustic transparency thereof; and wherein the holes of the base are larger in area compared to the holes of the substrate, or vice versa.

18. The vehicle according to claim 17, wherein one or more of the doors and/or covers comprise a lock mechanism; and/or wherein the base comprises opposing hinge arms and pins thereon which form a hinged engagement with the instrument panel.

19. The vehicle according to claim 18, further comprising a speaker holder, wherein the speaker holder comprises a first segment and a second segment that are slidably adjustable relative to each other to define a region therebetween adapted and configured to accept a speaker unit; and wherein the first and/or second segments comprise one or more clips adapted and configured to be accepted within a T-rails.

20. The vehicle according to claim 19, wherein the speaker holder is characterized by one or any combination of the following:
wherein the first and/or second segments comprise gripping elements;
wherein a cross-sectional profile of the speaker holder is generally polygonal with radiused corners;
wherein the first and second segments comprise a plurality of holes adapted and configured to permit sound to pass through;
wherein each of the first and second segments comprise a curved lip defining a space through which a speaker unit passes to become engaged with the speaker holder;
wherein the first and second segments each have overlapping segments;
wherein the first and second segments comprise a fastening mechanism to set a position of the first segment relative to the second segment, the fastening mechanism including a screw, a compression latch, or both; or
wherein the speaker holder further comprises a strap and buckle that connects at one end to the first segment and at an opposing end to the second segment.
